(19) United States
(12) Patent Application Publication
(10) Pub. No.: US 2025/0316723 A1
(43) Pub. Date: Oct. 9, 2025

(54) FUEL CELL STACK

(71) Applicant: TOYOTA BOSHOKU KABUSHIKI KAISHA, Aichi-ken (JP)

(72) Inventors: Kensuke DOI, Obu-shi (JP); Akihiro INUKAI, Okazaki-shi (JP); Haruyuki AONO, Aichi-ken (JP); Satoshi KAWABE, Ichinomiya-shi (JP); Harutaka ODA, Toyota-shi (JP)

(73) Assignee: TOYOTA BOSHOKU KABUSHIKI KAISHA, Aichi-ken (JP)

(21) Appl. No.: 19/092,650

(22) Filed: Mar. 27, 2025

(30) Foreign Application Priority Data
Apr. 4, 2024 (JP) 2024-060926

(51) Int. Cl. H01M 8/0258; H01M 8/0276; H01M 8/10; H01M 8/241; H01M 8/2483

(52) U.S. Cl. CPC H01M 8/0258; H01M 8/0276; H01M 8/241; H01M 8/2483; H01M 2008/1095

(57) ABSTRACT

A fuel cell stack includes multiple stacked unit cells. Each unit cell includes a first separator, a second separator, and a power generation portion sandwiched by the first separator and the second separator. A flow passage and a gasket are arranged between the first separator of a first unit cell and the second separator of a second unit cell. The gasket surrounds a supply manifold, the flow passage, and a discharge manifold. The gasket includes an annular body and a guide projection. The first separator of the first unit cell includes at least one first rib located adjacent to an inner peripheral side of the body. The second separator of the second unit cell includes at least one second rib located adjacent to the inner peripheral side of the body. The first rib and the second rib project so as to contact each other and extend to intersect each other.

### CROSS-REFERENCE TO RELATED APPLICATIONS

This application is based upon and claims the benefit of priority from Japanese Patent Application No. 2024-060926, filed on Apr. 4, 2024, the entire contents of which are incorporated herein by reference.

### BACKGROUND

### 1. Field

The present disclosure relates to a fuel cell stack.

### 2. Description of Related Art

A polymer electrolyte fuel cell includes a fuel cell stack in which multiple unit cells are stacked on one another. The unit cell includes a membrane electrode assembly, which is a power generation portion, a frame member surrounding the membrane electrode assembly, an anode separator, and a cathode separator. The membrane electrode assembly and the frame member are sandwiched by the anode separator and the cathode separator.

One of the stacked fuel cells may be referred to as a first unit cell. Another one of the stacked fuel cells having the cathode separator stacked on the anode separator of the first unit cell may be referred to as a second unit cell. In this configuration, a flow passage is formed between the anode separator of the first unit cell and the cathode separator of the second unit cell to allow a coolant to flow through.

Japanese Laid-Open Patent Publication No. 2009-252469 describes an example of a fuel cell separator having such a configuration. The fuel cell separator described in this publication includes a coolant inlet manifold configured to draw in a coolant, a flow passage through which the coolant flows, and a coolant outlet manifold configured to discharge the coolant from the flow passage. The coolant outlet manifold and the coolant inlet manifold are arranged at opposite sides of the flow passage. The flow passage is surrounded by an annular sealing member configured to seal the gap between the two adjacent separators. In addition, an end flow restriction piece projects from an inner peripheral surface of the seal member toward an inner side of the seal member. When the coolant flows from the coolant inlet manifold to the coolant outlet manifold, the end flow restriction piece hinders the coolant flowing through the flow passage in the proximity of the seal member. That is, the end flow restriction piece hampers sideward flow. This improves the efficiency of cooling the power generation portion.

The fuel cell stack needs further improvement in the efficiency of cooling the power generation portion so that the efficiency of generating power is further improved.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect of the present disclosure, a fuel cell stack includes multiple unit cells being stacked on one another. Each of the unit cells includes a power generation portion, a first separator, and a second separator. The power generation portion is sandwiched by the first separator and the second separator. The first separator includes a surface located at the power generation portion and including a first gas passage configured to supply a first reaction gas to the power generation portion. The second separator includes a surface located at the power generation portion and including a second gas passage configured to supply a second reaction gas to the power generation portion. One of the unit cells is referred to as a first unit cell. One of the unit cells that includes the second separator stacked on the first separator of the first unit cell is referred to as a second unit cell. A flow passage and a gasket are arranged between the first separator of the first unit cell and the second separator of the second unit cell. The flow passage is configured to allow a coolant for cooling the power generation portion to flow through. The flow passage is arranged between a supply manifold configured to supply the coolant and a discharge manifold configured to discharge the coolant. The gasket surrounds the supply manifold, the flow passage, and the discharge manifold. The gasket includes an annular body and a guide projection projecting from an inner peripheral surface of the body to the flow passage. The guide projection is configured to guide flow of the coolant toward an inner side of the body. The first separator of the first unit cell includes at least one first rib located adjacent to an inner peripheral side of the body. The second separator of the second unit cell includes at least one second rib located adjacent to the inner peripheral side of the body. The first rib and the second rib project so as to contact each other and extend to intersect each other.

Other features and aspects will be apparent from the following detailed description, the drawings, and the claims.

### BRIEF DESCRIPTION OF THE DRAWINGS

FIG. 1 is a perspective view of two unit cells included in an embodiment of a fuel cell stack and separated from each other.

FIG. 2 is a perspective view of an anode separator, a frame member to which a power generation portion is bonded, and a cathode separator that are included in a cell unit and separated from each other.

FIG. 3 is a plan view of the frame member to which the power generation portion is bonded.

FIG. 4 is a plan view of the anode separator to which a gasket is adhered.

FIG. 5 is a cross-sectional view taken along line 5-5 in FIG. 2.

FIG. 6 is an enlarged plan view of a portion shown in FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

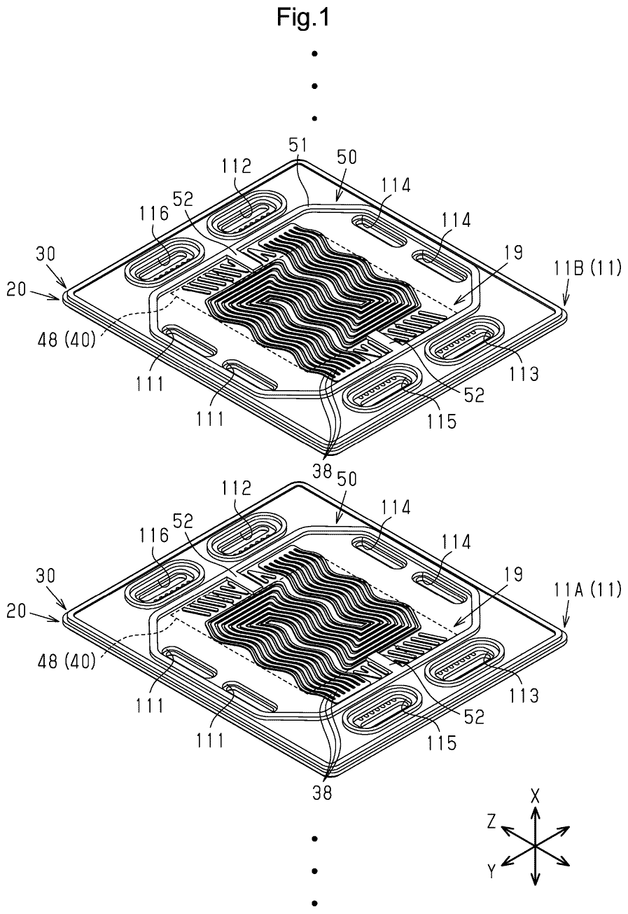

An embodiment of a fuel cell stack will now be described with reference to FIGS. 1 to 6.

For illustrative purposes, some components are shown exaggerated or simplified in the drawings. Therefore, the dimensional ratios of the components may differ from actual ratios.

As shown in FIG. 1, the fuel cell stack includes multiple unit cells 11 stacked on one another. FIG. 1 shows two unit cells 11A and 11B, which are included in the multiple unit cells 11 forming the fuel cell stack.

### Unit Cell 11

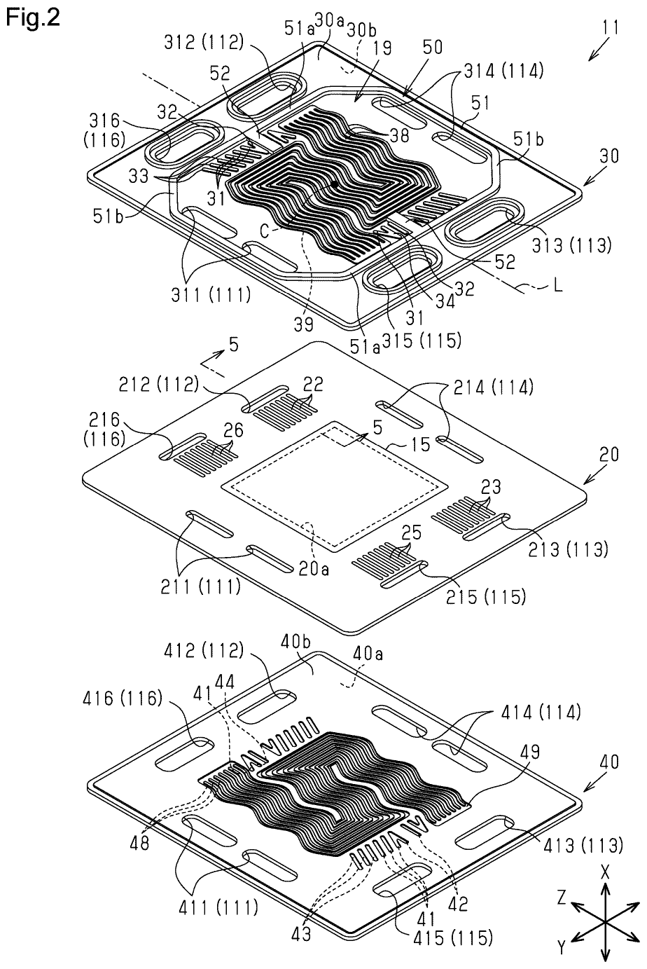

As shown in FIG. 2, the unit cell 11 includes a membrane electrode gas diffusion layer assembly (hereinafter, referred to as power generation portion 15), an electrically insulating frame member 20 surrounding the power generation portion 15, an anode separator 30, and a cathode separator 40. The power generation portion 15 and the frame member 20 are sandwiched by the anode separator 30 and the cathode separator 40. The unit cell 11 of the present embodiment has the form of a rectangular plate as a whole.

In the following description, the stacking direction of the multiple unit cells 11 is referred to as a first direction X. The direction in which the short sides of the unit cell 11 extend and the direction in which the long sides of the unit cell 11 extend are respectively referred to as a second direction Y and a third direction Z. The first direction X, the second direction Y, and the third direction Z form a Cartesian coordinate system.

The unit cell 11A (refer to FIG. 1) corresponds to any one of the unit cells 11, and the unit cell 11B (refer to FIG. 1) corresponds to one of the unit cells 11 having the cathode separator 40 stacked on the anode separator 30 of the unit cell 11A. The unit cell 11A is referred to as a first unit cell 11A. The unit cell 11B is referred to as a second unit cell 11B.

As shown in FIGS. 1 and 2, the unit cell 11 includes supply manifolds 111, 112, and 113 configured to respectively supply coolant, fuel gas, and oxidizing gas into the unit cell 11. The unit cell 11 further includes discharge manifolds 114, 115, and 116 configured to respectively discharge the coolant, the fuel gas, and the oxidizing gas to the outside of the unit cell 11.

The supply manifolds 111, 112, and 113 and the discharge manifolds 114, 115, and 116 extend through the unit cell 11 in the first direction X.

The supply manifold 111 is arranged at one side (lower left side in FIGS. 1 and 2) of the unit cell 11 in the second direction Y.

The discharge manifold 114 is arranged at the other side (upper right side in FIGS. 1 and 2) of the unit cell 11 in the second direction Y.

The supply manifold 113 and the discharge manifold 115 are arranged at one side (lower right side in FIGS. 1 and 2) of the unit cell 11 in the third direction Z. The supply manifold 113 and the discharge manifold 115 are separated from each other in the second direction Y.

The supply manifold 112 and the discharge manifold 116 are arranged at the other side (upper left side in FIGS. 1 and 2) of the unit cell 11 in the third direction Z. The supply manifold 112 and the discharge manifold 116 are separated from each other in the second direction Y.

### Power Generation Portion 15

As shown in FIG. 2, the power generation portion 15 includes a polymer electrolyte membrane (hereinafter, referred to as an electrolyte membrane), an anode electrode and a cathode electrode arranged on opposite surfaces of the electrolyte membrane, and gas diffusion layers arranged on two surfaces of the anode electrode and the cathode electrode.

The power generation portion 15 of the present embodiment has the form of a rectangle having two sides extending in the second direction Y and two sides extending in the third direction Z. In FIG. 2, the anode electrode is arranged on an upper surface of the electrolyte membrane, and the cathode electrode is arranged on a lower surface of the electrolyte membrane.

### Anode Separator 30

As shown in FIG. 2, the anode separator 30 is opposed to the anode electrode of the power generation portion 15.

The anode separator 30 includes supply manifolds 311, 312, and 313 and discharge manifolds 314, 315, and 316 respectively forming the supply manifolds 111, 112, and 113 and the discharge manifolds 114, 115, and 116.

The anode separator 30 includes a surface located at the power generation portion 15, defining a gas surface 30b provided with a gas passage 39 configured to supply a fuel gas to the power generation portion 15. The gas passage 39 is located between the supply manifold 312 and the discharge manifold 315 in the third direction Z. The gas passage 39 is defined by ribs projecting toward the power generation portion 15.

The anode separator 30 includes a surface located opposite from the power generation portion 15, defining a cooling surface 30a provided with cooling passage ribs 38.

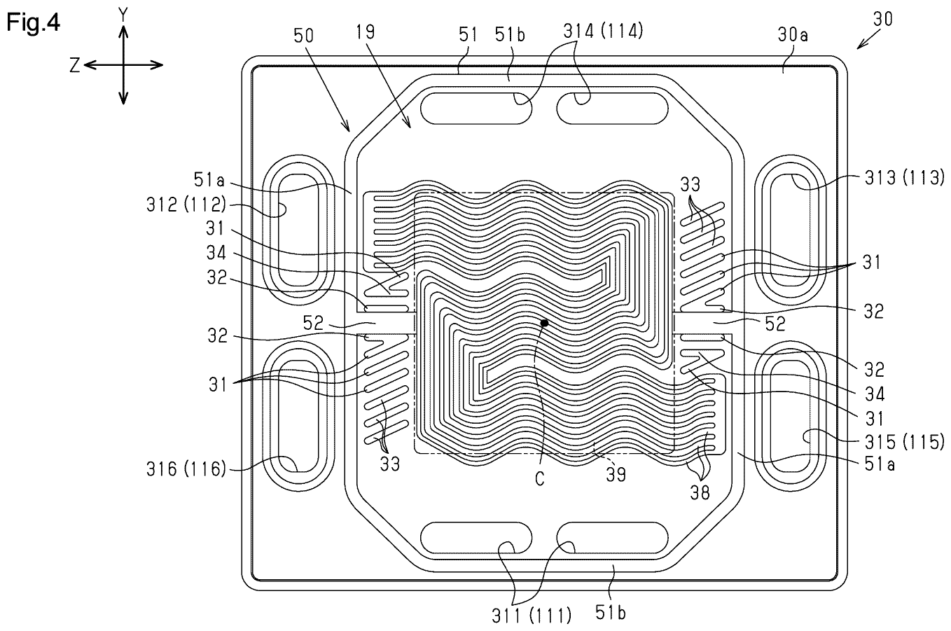

As shown in FIGS. 2 and 4, the cooling passage ribs 38 are substantially Z-shaped and extend from the supply manifold 312 toward the discharge manifold 315. Portions of the cooling passage ribs 38 extending in the third direction Z have the form of curved waves. The cooling passage ribs 38 are located between the supply manifold 311 and the discharge manifold 314 in the second direction Y.

The anode separator 30 of the present embodiment is formed by pressing a plate of metal such as stainless steel.

### Cathode Separator 40

As shown in FIG. 2, the cathode separator 40 is opposed to the cathode electrode of the power generation portion 15.

In the present embodiment, the cathode separator 40 and the anode separator 30 are identical in shape. The cathode separator 40 is arranged in a position such that the anode separator 30 is inverted with respect to an imaginary straight line L that extends in the third direction Z through the center, in the second direction Y, of the anode separator 30.

In the following description, some components of the cathode separator 40 may be referred to using reference numerals obtained by adding “10” to the reference numerals for the components in the anode separator 30, so that redundant description may be omitted.

The cathode separator 40 includes supply manifolds 411, 412, and 413 and discharge manifolds 414, 415, and 416 respectively forming the supply manifolds 111, 112, and 113 and the discharge manifolds 114, 115, and 116.

The cathode separator 40 includes a surface located at the power generation portion 15, defining a gas surface 40b provided with a gas passage 49 configured to supply an oxidizing gas to the power generation portion 15. The gas passage 49 is located between the supply manifold 413 and the discharge manifold 416 in the third direction Z. The gas passage 49 is defined by ribs projecting toward the power generation portion 15.

The cathode separator 40 includes a surface located opposite from the power generation portion 15, defining a cooling surface 40a provided with cooling passage ribs 48.

The cooling passage ribs 48 are substantially S-shaped and extend from the supply manifold 413 toward the discharge manifold 416. Portions of the cooling passage ribs 48 extending in the third direction Z have the form of curved waves. The cooling passage ribs 48 are located between the supply manifold 411 and the discharge manifold 414 in the second direction Y.

The cathode separator 40 of the present embodiment is formed by pressing a plate of metal such as stainless steel.

### Flow Passage 19

As shown in FIG. 1, the cooling passage ribs 38 of the anode separator 30 and the cooling passage ribs 48 of the cathode separator 40, which are adjacent to each other in the first direction X, define a flow passage 19 through which the coolant flows.

### Gasket 50

As shown in FIG. 1, a gasket 50 is arranged between the anode separator 30 of the first unit cell 11A and the cathode separator 40 of the second unit cell 11B to seal the gap between the anode separator 30 and the cathode separator 40.

As shown in FIGS. 2 and 4, the gasket 50 is mounted on the cooling surface 30a of the anode separator 30 and surrounds the supply manifold 111, the flow passage 19, and the discharge manifold 114. The gasket 50 is fixed to the anode separator 30 by, for example, an adhesive.

The gasket 50 includes an annular body 51 and a guide projection 52. The guide projection 52 projects from an inner peripheral surface of the body 51 toward the flow passage 19 and guides the flow of the coolant toward the inner side of the body 51.

“Annular” shapes include any structure that forms a loop, that is, a continuous shape with no ends. “Annular” shapes include, but are not limited to, a circular shape, an elliptic shape, and a polygonal shape with sharp or rounded corners.

The body 51 includes two first portions 51a extending in the second direction Y and separated from each other in the third direction Z and two second portions 51b connecting two ends of one of the two first portions 51a to two ends of the other one of the two first portions 51a. In the present embodiment, each of the second portions 51b includes a straight portion extending in the third direction Z and inclined portions continuous with two ends of the straight portion and inclined inward with respect to the second direction Y as the inclined portions extend outward in the third direction Z.

The guide projection 52 is arranged at an intermediate position of the anode separator 30 in the second direction Y and projects from the first portion 51a in the third direction Z. In the present embodiment, the two first portions 51a each include one guide projection 52.

The guide projection 52 includes a distal end that is in contact with the cooling passage rib 38.

### Frame Member 20

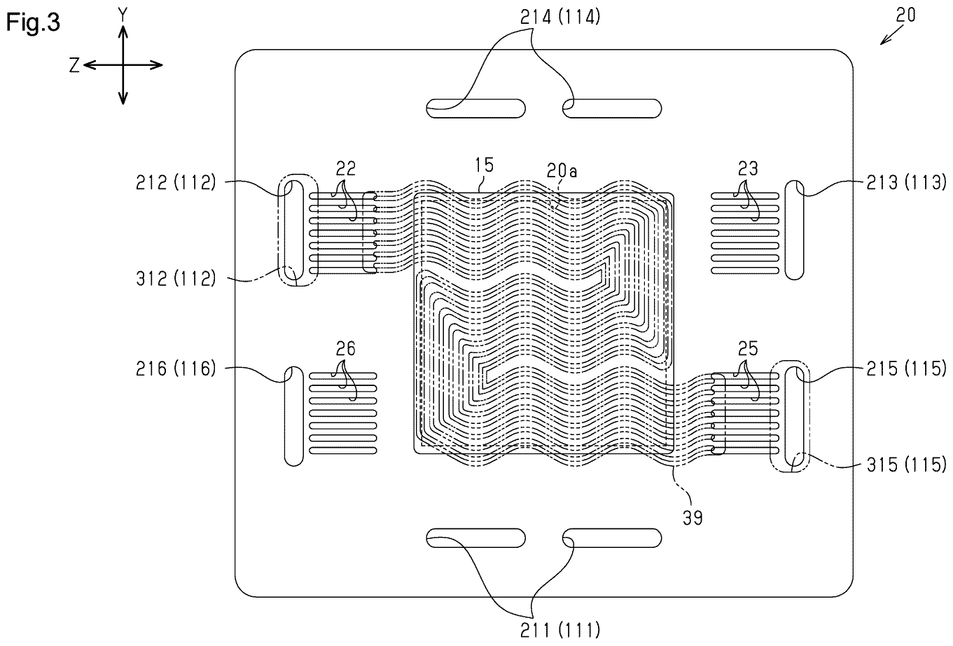

As shown in FIGS. 2 and 3, an opening 20a extends through the center, in the first direction X, of the frame member 20. The opening 20a of the present embodiment has the form of a rectangle having two sides extending in the second direction Y and two sides extending in the third direction Z.

Peripheral edges of the power generation portion 15 are joined to peripheral walls defining the opening 20a from one side (upper side in FIG. 2) in the first direction X.

The frame member 20 includes supply manifolds 211, 221, and 223 and discharge manifolds 224, 225, and 226 respectively forming the supply manifolds 111, 112, and 113 and the discharge manifolds 114, 115, and 116.

Multiple supply through holes 22 and 23 and multiple discharge through holes 25 and 26 extend through the frame member 20 in the first direction X. The supply through holes 22 and 23 and the discharge through holes 25 and 26 are each elongated in the third direction Z.

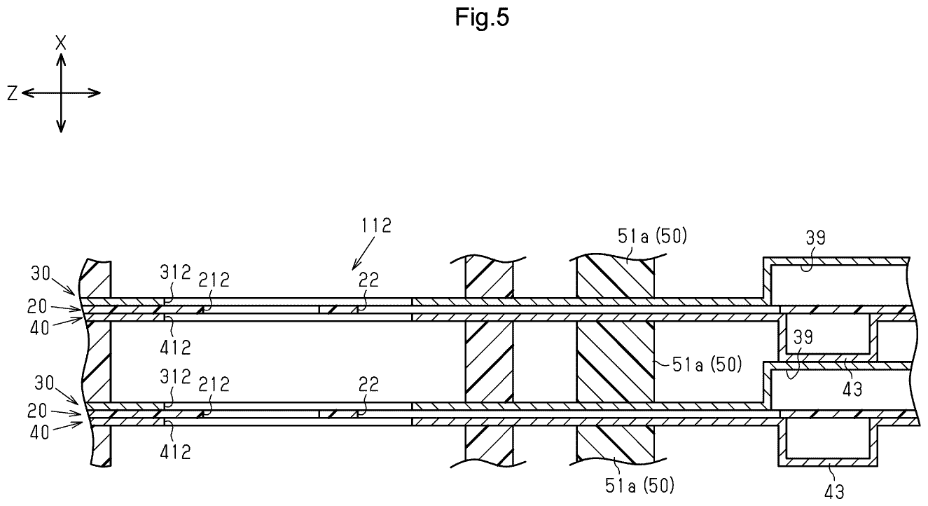

As shown in FIG. 5, the fuel gas flowing in the supply manifold 112 is supplied to the gas passage 39 through the supply manifold 312 and the supply through hole 22.

Although not shown, off-gas of the fuel gas flowing through the gas passage 39 is discharged to the discharge manifold 115 through the discharge through hole 25 and the discharge manifold 315.

The oxidizing gas flowing in the supply manifold 113 is supplied to the gas passage 49 through the supply manifold 413 and the supply through hole 23.

Off-gas of the oxidizing gas flowing through the gas passage 49 is discharged to the discharge manifold 116 through the discharge through hole 26 and the discharge manifold 416.

### Configuration Detail of Anode Separator 30 and Cathode Separator 40

As shown in FIG. 4, the anode separator 30 includes first ribs 31, first auxiliary ribs 32, third ribs 33, and fourth ribs 34.

The first ribs 31, the first auxiliary ribs 32, the third ribs 33, and the fourth ribs 34 project in a direction opposite from the power generation portion 15 and are arranged adjacent to the body 51 of the gasket 50. In the present embodiment, the first ribs 31, the first auxiliary ribs 32, the third ribs 33, and the fourth ribs 34 are arranged symmetrically with respect to a center C in the plane direction of the anode separator 30. Thus, the following description will focus on the first ribs 31, the first auxiliary ribs 32, the third ribs 33, and the fourth ribs 34 that are arranged at the right side of the power generation portion 15 in FIG. 4.

At the right side of the power generation portion 15 in FIG. 4, one first auxiliary rib

32, one fourth rib 34, and one first rib 31 are arranged in this order from the guide projection 52 at the side of the guide projection 52 toward the supply manifold 111 in the second direction Y.

Also, one first auxiliary rib 32, three first ribs 31, and three third ribs 33 are arranged in this order from the guide projection 52 at the side of the guide projection 52 toward the discharge manifold 114 in the second direction Y.

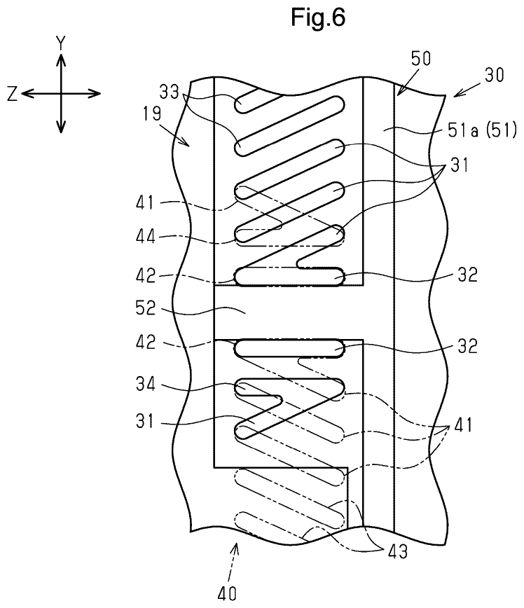

As shown in FIG. 6, the first ribs 31 are each inclined with respect to the second direction Y and the third direction Z so as to approach the discharge manifold 114 (upper side in FIG. 6) in the second direction Y as the first ribs 31 extend toward the body 51 in the third direction Z.

The first auxiliary ribs 32 are each arranged between the first rib 31 and the guide projection 52 and extend in the third direction Z.

The guide projection 52 is sandwiched by the first auxiliary ribs 32 located at opposite sides of the guide projection 52 in the second direction Y.

At the side of the guide projection 52 toward the discharge manifold 114 in the second direction Y, the first rib 31 that is located adjacent to the first auxiliary rib 32 includes an inner end continuous with an inner end of the first auxiliary rib 32.

The third rib 33 is similar in shape to the first rib 31.

The fourth rib 34 extends in the third direction Z. The fourth rib 34 includes an outer end continuous with an outer end of the first rib 31.

As shown in FIG. 2, the cathode separator 40 includes second ribs 41, second auxiliary ribs 42, fifth ribs 43, and sixth ribs 44.

As described above, in the present embodiment, the cathode separator 40 is identical in shape to the anode separator 30. Therefore, the first ribs 31, the first auxiliary ribs 32, the third ribs 33, and the fourth ribs 34 of the anode separator 30 that are inverted correspond to the second ribs 41, the second auxiliary ribs 42, the fifth ribs 43, and the sixth ribs 44.

The first ribs 31 of the anode separator 30 indicated by solid lines in FIG. 6 and the second ribs 41 of the cathode separator 40 indicated by double-dashed lines in FIG. 6 project so as to contact each other. In addition, the first ribs 31 and the second ribs 41 extend so as to intersect each other.

The first auxiliary ribs 32 of the anode separator 30 indicated by solid lines in FIG. 6 and the second auxiliary ribs 42 of the cathode separator 40 indicated by double-dashed lines in FIG. 6 project so as to contact each other.

In the present embodiment, the first direction X, the second direction Y, and the third direction Z respectively correspond to a stacking direction, an arrangement direction, and a width-wise direction according to the present disclosure. The anode separator 30 and the cathode separator 40 respectively correspond to a first separator and a second separator according to the present disclosure. The gas passage 39 and the gas passage 49 respectively correspond to a first gas passage and a second gas passage according to the present disclosure. The fuel gas and the oxidizing gas respectively correspond to a first reaction gas and a second reaction gas according to the present disclosure.

### Operation of the Present Embodiment

As shown in FIG. 4, when the coolant flows into the flow passage 19 from the supply manifold 111 to the proximity of the body 51 of the gasket 50, the guide projections 52 guide the flow of the coolant toward the inner side of the body 51. This structure hinders the coolant from flowing through the proximity of the body 51 of the gasket 50 at the downstream side of the guide projections 52 in the flow passage 19. Moreover, at the downstream side of the guide projections 52, the coolant readily flows through a portion of the flow passage 19 separated inward from the body 51, that is, a portion close to the power generation portion 15, where the power generation portion 15 is cooled highly efficiently. In addition, the first ribs 31 and the second ribs 41 arranged in the proximity of the body 51 hinder the coolant from flowing through the proximity of the body 51. With this structure, while the coolant is hindered from flowing through the proximity of the body 51 of the gasket 50, the coolant readily flows through a portion separated inward from the body 51, that is, a portion close to the power generation portion 15, where the power generation portion 15 is cooled highly efficiently. Thus, the efficiency of cooling the power generation portion 15 is improved.

As shown in FIG. 5, even when the anode separator 30 of the first unit cell 11A and the cathode separator 40 of the second unit cell 11B are misaligned in a planar direction that is orthogonal to the first direction X, the first ribs 31 and the second ribs 41 extend so as to intersect each other. Thus, the state in which the first ribs 31 are in contact with the second ribs 41 is likely to be maintained. This readily ensures the surface pressure between the anode separator 30 of the first unit cell 11A and the cathode separator 40 of the second unit cell 11B. With this structure, the fuel gas readily flows toward the power generation portion 15 along the gas passage 39, and the oxidizing gas readily flows toward the power generation portion 15 along the gas passage 49. Thus, the reaction gases are supplied to the power generation portion 15 in a preferred manner.

### Advantages of the Present Embodiment

(1) The gasket 50 includes the annular body 51 and the guide projections 52. The guide projections 52 project from the inner peripheral surface of the body 51 toward the flow passage 19 and guide the flow of the coolant toward the inner side of the body 51. The first ribs 31 of the anode separator 30 of the first unit cell 11A and the second ribs 41 of the cathode separator 40 of the second unit cell 11B extend so as to intersect each other.

These structures has the operation described above, thereby further improving the power generation efficiency.

(2) The first ribs 31 and the second ribs 41 each extend so as to be inclined with respect to the second direction Y and the third direction Z.

With this structure, the area of a rectangle having vertices corresponding to two ends of the first rib 31 and two ends of the second rib 41 is decreased as compared to a structure in which the first ribs 31 extend in the second direction Y and the second ribs 41 extend in the third direction Z. This allows for a compact arrangement without shortening the first ribs 31 and the second ribs 41. Therefore, while avoiding a decrease in the surface pressure caused by misalignment of the anode separator 30 of the first unit cell 11A with the cathode separator 40 of the second unit cell 11B, the first ribs 31 and the second ribs 41 will not adversely affect the flow of the coolant in the flow passage 19.

(3) The first ribs 31 and the second ribs 41 are located closer to the supply manifold 111 than the guide projections 52 are in the second direction Y.

With this structure, at the upstream side of the guide projections 52 in the proximity of the body 51, pressure loss is increased by the first ribs 31 and the second ribs 41 arranged closer to the supply manifold 111 than the guide projections 52 are in the second direction Y. Thus, at the upstream side of the guide projections 52 in the flow passage 19, the coolant is hindered from flowing through the proximity of the body 51 of the gasket 50. Accordingly, the coolant easily flows through a portion of the flow passage 19 separated inward from the body 51, that is, a portion close to the power generation portion 15, where the efficiency of cooling the power generation portion 15 is high. Thus, the efficiency of cooling the power generation portion 15 is improved.

(4) The first ribs 31 and the second ribs 41 are arranged closer to the discharge manifold 114 than the guide projections 52 are in the second direction Y.

With this structure, at the downstream side of the guide projections 52 in the proximity of the body 51, pressure loss is increased by the first ribs 31 and the second ribs 41 arranged closer to the discharge manifold 114 than the guide projections 52 are in the second direction Y. Thus, the coolant is hindered from flowing through the proximity of the body 51 of the gasket 50 at the downstream side of the guide projections 52 in the flow passage 19. Accordingly, the coolant easily flows through a portion of the flow passage 19 separated inward from the body 51, that is, a portion close to the power generation portion 15, where the power generation portion 15 is cooled highly efficiently. Thus, the efficiency of cooling the power generation portion 15 is improved.

(5) The anode separator 30 and the cathode separator 40 are identical in shape. The guide projections 52 are arranged at an intermediate position of the anode separator 30 in the second direction Y and project in the third direction Z.

This structure allows for reduction in the number of components in the separators 30 and 40.

(6) The first auxiliary ribs 32 are each arranged between the first rib 31 and the guide projection 52 and extend in the third direction Z. The second auxiliary ribs 42 are each arranged between the second rib 41 and the guide projection 52 and extend in the third direction Z.

The first rib 31 and the second rib 41 extend so as to intersect each other. Such a structure imposes limitations on arrangement of the intersection between the first rib 31 and the second rib 41 in the proximity of the guide projection 52 in the second direction Y. Therefore, when the first rib 31 and the second rib 41 are located at each of opposite sides of the guide projection 52, it is difficult to shorten the distance between the intersections located at opposite sides, that is, the portions of the first rib 31 and the second rib 41 where the surface pressure is increased.

In this regard, in the structure of the present embodiment, the anode separator 30 and the cathode separator 40 respectively include the first auxiliary rib 32 and the second auxiliary rib 42. This allows the surface pressure to be increased at a position closer to the guide projection 52 than the intersections described above. This readily ensures the surface pressure between the anode separator 30 of the first unit cell 11A and the cathode separator 40 of the second unit cell 11B. With this structure, the fuel gas readily flows toward the power generation portion 15 along the gas passage 39, and the oxidizing gas readily flows toward the power generation portion 15 along the gas passage 49. Thus, the reaction gases are supplied to the power generation portion 15 in a preferred manner. Thus, the power generation efficiency is further improved.

### Modified Examples

The present embodiment may be modified as described below. The present embodiment and the following modified examples can be combined as long as the combined modified examples remain technically consistent with each other.

In the embodiment, the distal end of the guide projection 52 is in contact with the cooling passage rib 38. Alternatively, the distal end of the guide projection 52 may be spaced apart by a gap from the cooling passage rib 38 in the third direction Z. In this case, the width of the gap may be changed.

The distance from the body 51 of the gasket 50 to each of the first rib 31, the first auxiliary rib 32, the third rib 33, and the fourth rib 34 may be changed. The same applies to the second rib 41, the second auxiliary rib 42, the fifth rib 43, and the sixth rib 44.

The width of the first auxiliary rib 32 in the second direction Y may be increased as the first auxiliary rib 32 extends inward. The same applies to the second auxiliary rib 42.

The first auxiliary rib 32 is not limited to one extending in the third direction Z. For example, the first auxiliary rib 32 may be inclined toward the discharge manifold 114 as the first auxiliary rib 32 extends inward. The same applies to the second auxiliary rib 42.

In the embodiment, the guide projection 52 is sandwiched by the first auxiliary ribs 32 arranged at opposite sides of the guide projection 52 in the second direction Y. Alternatively, the first auxiliary ribs 32 may be spaced apart from the guide projection 52 in the second direction Y.

The first auxiliary rib 32 and the second auxiliary rib 42 may be omitted.

In the embodiment, the anode separator 30 and the cathode separator 40 are identical in shape. However, the anode separator 30 and the cathode separator 40 may have different shapes.

In the embodiment, the first ribs 31 are arranged at opposite sides of the guide projection 52 in the second direction Y. Instead, the first rib 31 may be provided at only one side of the guide projection 52 in the second direction Y. The same applies to the second rib 41.

In the embodiment, the first rib 31 extends so as to be inclined with respect to the second direction Y and the third direction Z. However, there is no limit to such a structure. In an example, as long as the first rib 31 intersects the second rib 41, the first rib 31 may extend in the second direction Y, and the second rib 41 may extend in the third direction Z.

In the embodiment, the first ribs 31 are arranged at opposite sides in the third direction Z. Alternatively, the first rib 31 may be arranged at only one side in the third direction Z. The same applies to the second rib 41.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell stack, comprising:
multiple unit cells being stacked on one another, each of the unit cells including a power generation portion, a first separator, and a second separator, the power generation portion being sandwiched by the first separator and the second separator, wherein the first separator includes a surface located at the power generation portion and including a first gas passage configured to supply a first reaction gas to the power generation portion,
the second separator includes a surface located at the power generation portion and including a second gas passage configured to supply a second reaction gas to the power generation portion,
one of the unit cells is referred to as a first unit cell, one of the unit cells that includes the second separator stacked on the first separator of the first unit cell is referred to as a second unit cell,
a flow passage and a gasket are arranged between the first separator of the first unit cell and the second separator of the second unit cell, the flow passage is configured to allow a coolant for cooling the power generation portion to flow through,
the flow passage is arranged between a supply manifold configured to supply the coolant and a discharge manifold configured to discharge the coolant,
the gasket surrounds the supply manifold, the flow passage, and the discharge manifold,
the gasket includes
an annular body, and
a guide projection projecting from an inner peripheral surface of the body to the flow passage, the guide projection being configured to guide flow of the coolant toward an inner side of the body,
the first separator of the first unit cell includes at least one first rib located adjacent to an inner peripheral side of the body,
the second separator of the second unit cell includes at least one second rib located adjacent to the inner peripheral side of the body, and
the first rib and the second rib project so as to contact each other and extend to intersect each other.

2. The fuel cell stack according to claim 1, wherein
a width-wise direction refers to a direction that is orthogonal to a stacking direction of the unit cells and an arrangement direction of the supply manifold and the discharge manifold, and
the first rib and the second rib each extend to be inclined with respect to the arrangement direction and the width-wise direction.

3. The fuel cell stack according to claim 1, wherein
the at least one first rib includes a first rib arranged closer to the supply manifold than the guide projection is, in an arrangement direction of the supply manifold and the discharge manifold, the arrangement direction being orthogonal to a stacking direction of the unit cells, and
the at least one second rib includes a second rib arranged closer to the supply manifold than the guide projection is, in the arrangement direction.

4. The fuel cell stack according to claim 3, wherein
the at least one first rib includes a first rib arranged closer to the discharge manifold than the guide projection is, in the arrangement direction, and
the at least one second rib includes a second rib arranged closer to the discharge manifold than the guide projection is, in the arrangement direction.

5. The fuel cell stack according to claim 4, wherein
the first separator and the second separator are identical in shape,
a width-wise direction refers to a direction that is orthogonal to the stacking direction and the arrangement direction, and
the guide projection is arranged at an intermediate position of the first separator in the arrangement direction and projects in the width-wise direction.

6. The fuel cell stack according to claim 5, wherein
the first separator of the first unit cell and the second separator of the second unit cell respectively include a first auxiliary rib and a second auxiliary rib projecting so as to contact each other,
the first auxiliary rib is arranged between the first rib and the guide projection and extends in the width-wise direction, and
the second auxiliary rib is arranged between the second rib and the guide projection and extends in the width-wise direction.
